(19) United States
(12) Patent Application Publication
(10) Pub. No.: US 2002/0154372 A1
(43) Pub. Date: Oct. 24, 2002

(54) Power and optical frequency monitoring system and transmission system of frequency-modulated optical signal

(76) Inventors: Yeun Chol Chung, Daejon-city (KR); Keun Ju Park, Jeollanam-do (KR); Chun Ju Yun, Deajon-city (KR)

Correspondence Address: HARNESS, DICKEY & PIERCE, P.L.C., P.O. BOX 828, BLOOMFIELD HILLS, MI, 48303, US

(21) Appl. No.: 10/131,421

(22) Filed: Apr. 24, 2002

(30) Foreign Application Priority Data
Apr. 24, 2001 (KR) 2001-22089

(51) Int. Cl. H04J 14/02; H04B 10/04

(52) U.S. Cl. 359/182; 359/124

(57) ABSTRACT

The present invention relates to a monitoring system that observes the power and optical frequency of a frequency-modulated optical signal, which is utilized in the communication network employing the WDM (wavelength division multiplexing) method. The monitoring system comprises demultiplex means for demultiplexing the frequency-modulated optical signal outputted from a transmitter including frequency-modulation means, photo-detection means for converting the output of demultiplex means into an electrical signal, and extraction means for extracting the power and optical frequency of an optical signal by measuring the magnitude of an amplitude-modulated tone.

### BACKGROUND OF THE INVENTION

1. Field of the Invention

The present invention relates to a monitoring system that monitors the power and optical frequency of an optical signal, which is utilized in an optical communication network using the wavelength division multiplexing method. In more detail, it relates to a monitoring device that observes the power and optical frequency of an optical signal using demultiplexer and photo-detectors at monitoring nodes, after modulating the frequency of an optical signal outputted from a transmitter, in order to operate effectively an optical communication network of the wavelength division multiplexing method.

2. Description of the Related Art

An optical communication network using the wavelength division multiplexing (WDM) method sets the multiplexed communication cannels according to the wavelength, and transmits multiple optical signals through the multiplexed communication cannels with high speed so that it can effectively make a communication network maintain high speed and wide bandwidth.

However, the optical frequency of an optical signal can be changed due to aging and temperature variation in an optical communication network of a wavelength division multiplexing method, and the optical frequency variation of each channel due to the different transmission characteristics of optical elements can lead to the output power variation of each channel and the crosstalk between neighboring is channels so that those may affect the system performance largely.

In this communication network, therefore, it is necessary to monitor the power and optical frequency of an optical input/output signal at each node, for operating the communication network effectively. As the prior art in order to fulfill this requirement, monitoring method utilizing a band-pass filter such as an acoustic-optic tunable filer or a temperature tunable etalon filter is used to observe the power and optical frequency of an optical signal on each channel.

However, the prior art is only useful in term of simple configuration and easy embodiment, it has some disadvantages such as low reliability and resolution.

As another conventional method to monitor the power and optical frequency of an optical signal at each node, it is to observe an optical frequency by passing the extracted optical signal components through a log amplifier after extracting an optical signal using an Arrayed Waveguide Grating (AWG) demultiplexer, or to observe the power and optical frequency by inputting the separated optical signal components into a photodiode-array after separating an optical signal using a diffraction grating.

However, the conventional methods mentioned above require a complex configuration and embodiment, and are uneconomical due to expensive components in comparison with the measurement precision required by a monitoring system.

To resolve problems mentioned as above, the following method is implemented: the current for generating a pilot tone having a constant rate in comparison with an output power is supplied to a semiconductor laser, the magnitude of the pilot tone is detected at arbitrary node, the power of an optical signal is monitored by dividing the magnitude of the detected pilot tone with a constant ratio, and the optical frequency is monitored by passing the signal through the fixed Fabry-Perot etalon filter. Further, an optical frequency monitoring method using an amplitude-modulated pilot tone and an Arrayed Waveguide Grating (AWG) is implemented. In here, the current for generating a pilot tone means a small magnitude and low frequency signal besides data signals, which is applied to a transmitting semiconductor laser for generating a pilot tone. The frequency of a pilot tone is less than LMHZ to avoid the interference with a data signal having Gb/s transmitting speed.

However, the foregoing conventional method shows disadvantages as following: the monitoring performance is degraded due to the cross gain modulation (XGM) phenomenon of an optical amplifier and the Stimulated Raman Scattering (SRS) phenomenon of a fiber optic, and the efficiency of data signal is declined due to the interference between an amplitude-modulated pilot tone and a transmitting data signal.

Consequently, the foregoing subject of this invention can be solved effectively. The object of the present invention is to provide a monitoring system, which observes the power and optical frequency of an optical signal using demultiplexer and photo-detectors at monitoring nodes after modulating the frequency of an optical signal outputted from a transmitter, in order to operate effectively an optical communication network using a wavelength division multiplexing method.

### SUMMARY OF THE INVENTION

The present invention relates to a monitoring system that observes the power and optical frequency of a frequency-modulated optical signal, which is utilized in the communication network employing the WDM (wavelength division multiplexing) method. The monitoring system comprises demultiplex means for demultiplexing the frequency-modulated optical signal outputted from a transmitter including frequency-modulation means, photo-detection means for converting the output of demultiplex means into an electrical signal, and extraction means for extracting the power and optical frequency of an optical signal by measuring the magnitude of an amplitude-modulated tone.

A transmission system including the frequency modulation means, and a monitoring system for extracting a power/optical frequency of a frequency-modulated optical signal can be realized easily and economically. Furthermore, those system may prevent the performance degradation due to the cross gain modulation (XGM) phenomenon of an optical amplifier and the Stimulated Raman Scattering (SRS) phenomenon of a fiber optic, and the interference between an amplitude-modulated pilot tone and a transmitting data signal. Accordingly, an optical communication network using a wavelength division multiplexing method can be operated and managed effectively.

### BRIEF DESCRIPTION OF THE DRAWINGS

FIG. 1 is a configuration diagram depicting the preferred embodiment of a transmitter that is located at each node and generates a frequency-modulated optical signal in accordance with WDM optical communication network of the present invention.

FIG. 2 is a diagram illustrating the spectrum of tone measured by a spectrum analyzer.

FIG. 3 is a configuration diagram depicting another embodiment of a transmitter that modulates the frequency of optical signals by utilizing a phase modulator in accordance with the present invention.

FIG. 4 is a configuration diagram depicting another embodiment of a transmitter that modulates the frequency of optical signals by utilizing the temperature control circuit of a laser in accordance with the present invention.

FIG. 5 is a configuration diagram depicting the preferred embodiment of a monitoring device that observes the power and frequency of an optical signal.

FIG. 6 is a diagram illustrating the transmission characteristics of an Arrayed Waveguide Grating with 200 GHZ channel distance and 30 dB crosstalk.

FIG. 7 is a configuration diagram depicting another embodiment of a monitoring device that observes an optical frequency using a demultiplexer in accordance with the present invention.

FIG. 8 is a diagram illustrating the magnitude and magnitude ratio of amplitude modulated tones according to the optical frequency, here, the amplitude-modulated tones are generated after the optical signal modulated by 14 KHZ (a fifth laser in FIG. 1) is passed the 1×8 Arrayed waveguide Grating and photo-detector in the present invention.

FIG. 9 is diagram showing experimental results measured before transmitting the WDM optical signals of seven channels through the single mode fiber optic, and illustrating the power error and optical frequency error between an optical signal measured by a power/optical frequency monitoring system and an optical signal measured by a commercial multi-wavelength measurement system.

FIG. 10 is a diagram illustrating the ratio (modulation index) of the component modulated by color dispersion of fiber optic to the average power of an optical signal according to the length of a fiber optic.

FIG. 11 is a exemplary diagram illustrating experimental results that is measured the power and optical frequency of a WDM optical signals of seven channels after transmitting the signal through a single mode fiber optic (640 km long) in accordance with the present invention.

FIG. 12 is a diagram illustrating the error of the power and optical frequency of single channel while changing the power of WDM optical signals of seven channels after transmitting the signal through a single mode fiber optic (640 km long) in accordance with the present invention.

FIG. 13 is a diagram illustrating the bit error rate of a data signal having 2.5 GB/s speed, with respect to the case of suppressing and case of non-suppressing the amplitude-modulated component, when the power and optical frequency of a WDM optical signal is monitored by a monitoring system in accordance with the present invention.

### DETAILED DESCRIPTION OF THE EMBODIMENTS

Hereinafter, referring to appended drawings, the structures and the operation procedures of the embodiments of the present invention are described in detail.

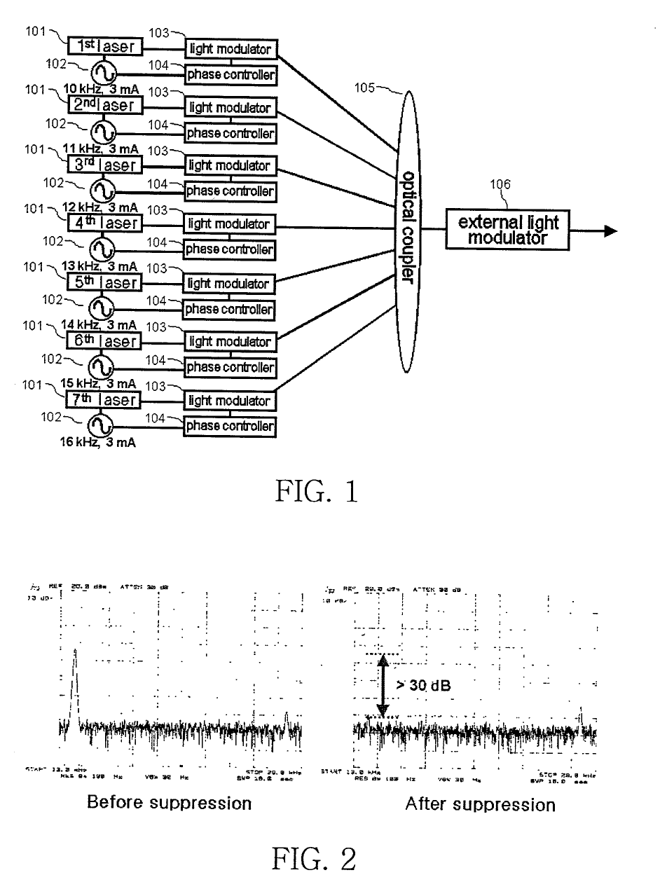

FIG. 1 is a configuration diagram depicting the preferred embodiment of a transmitter that is located at each node and generates a frequency-modulated optical signal in accordance with WDM optical communication network of the present invention. The transmitter for generating the frequency-modulated optical signal as shown in FIG. 1 comprises a Distributed FeedBack (DFB) laser (101) for generating an optical signal, a tone generator (102) for modulating the amplitude and frequency of an optical signal simultaneously by applying a tone signal to an optical signal, a phase controller (104) for controlling the phase of a tone signal, a light modulator (103) controlled by a phase controller for suppressing the amplitude variation of an optical signal of which amplitude is modulated by a tone generator, an optical coupler (105) for combining the optical signals of which frequency is modulated, and an external light modulator (106) for modulating an optical signal into high speed signal.

The optical frequencies of 7 lasers (101) in FIG. 1 are operated in the range from 192.4 THz to 193.6 THZ, respectively. The frequencies of 7 tone generators (102) range from 10 KHZ to 16 KHZ with 1 KHZ interval. The sinusoidal current having 3 mA amplitude of a tone generator is supplied to each laser. Accordingly, the amplitude and optical frequency of the optical signal outputted from a laser is modulated simultaneously. When the optical signal component of which amplitude is modulated is transmitted, performance degradation may be occurred due to the cross gain modulation phenomenon of an optical amplifier and the Stimulated Raman Scattering phenomenon of a fiber optic, the efficiency of an optical signal may be declined due to the interference with transmitting data signal. In order to suppress problems mentioned above, a light modulator (103) and a phase controller (104) are utilized in the present invention. A phase controller (104) converts the phase of sinusoidal current generated by a tone generator (102) into inverse phase. Therefore, the amplitude-modulated component of an optical signal is suppressed by applying the sinusoidal current having inverse phase to a light modulator (103). Accordingly, the present invention is different from the conventional monitoring method utilizing the amplitude-modulated pilot tone, prevents from occurring the cross gain modulation phenomenon of an optical amplifier, degrading the performance of a monitoring system due to non-linearity of a fiber optic, and the penalty of data signal caused by the interference.

FIG. 2 is a diagram illustrating the spectrum of tone measured by a spectrum analyzer.

Since the sinusoidal current having inverse phase is applied to a light modulator (103) in FIG. 1, FIG. 2 shows the amplitude-modulated tone is suppressed more than 30 dB.

Therefore, the optical signal outputted from each laser includes the frequency-modulated component instead of amplitude-modulated component of an optical signal. Accordingly, the variation amount of an optical frequency of each laser is measured within the range of 0.3-0.56 GHZ. Not only the method as shown in FIG. 1, but also the various methods for modulating the frequency of an optical signal may be used.

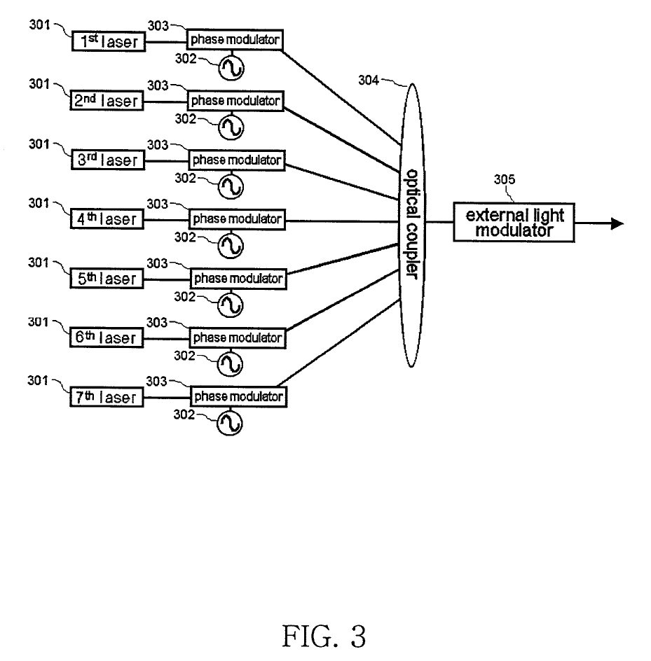

FIG. 3 is a configuration diagram depicting another embodiment of a transmitter that modulates the frequency of optical signals by utilizing a phase modulator in accordance with the present invention.

The optical signal outputted from each laser (301) is inputted into a phase modulator (303). When the phase modulator (303) is controlled by a RF-signal generator (302), the frequency of an optical signal outputted from each laser (301) is modulated.

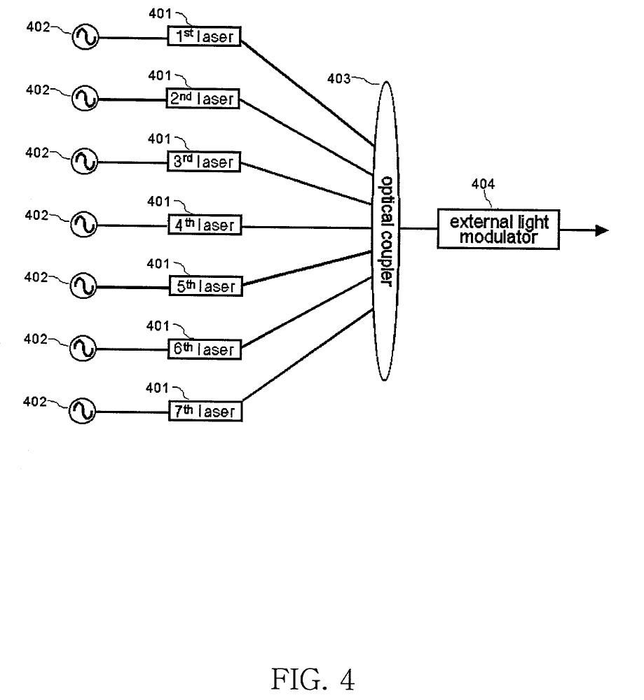

FIG. 4 is a configuration diagram depicting another embodiment of a transmitter that modulates the frequency of optical signals by utilizing the temperature control circuit of a laser in accordance with the present invention.

If the temperature of each laser (401) is changed by a temperature control circuit (402), the frequency of an optical signal outputted from each laser (401) is modulated.

From now on, the operating principle of a monitoring system that monitors the power and optical frequency of an optical signal in WDM optical communication network will be discussed.

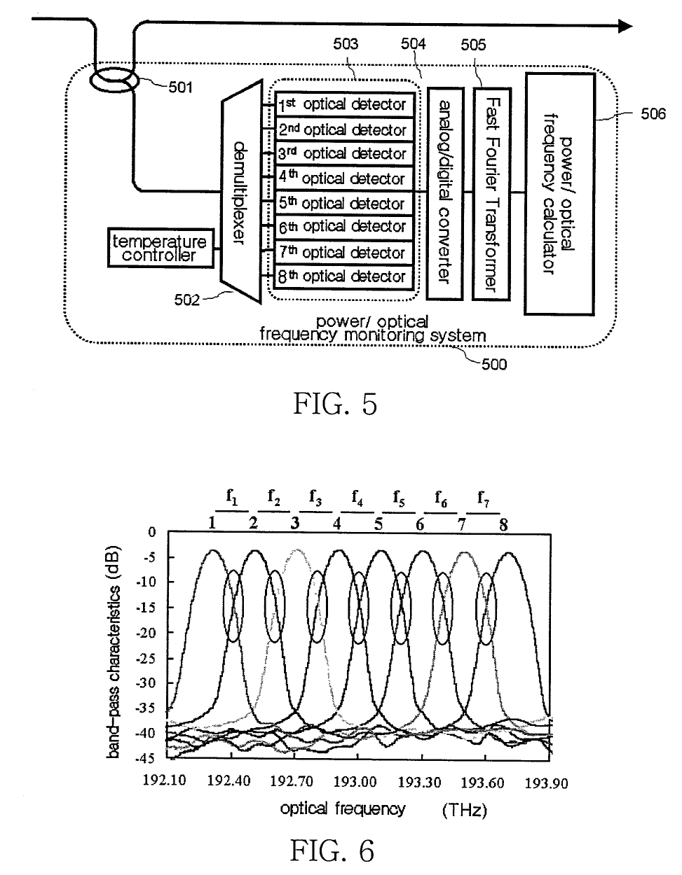

FIG. 5 is a configuration diagram depicting the preferred embodiment of a monitoring device that observes the power and frequency of an optical signal.

The monitoring system shown in FIG. 5 comprises a star coupler (501) for extracting the optical signal including the frequency-modulated component from a fiber optic line, a demultiplexer (502) for demultiplexing an optical signal outputted from a star coupler (501), a plurality of photo-detector for measuring the magnitude of an optical signal changed the transmission characteristics by a demultiplexer (502), an analog/digital converter (504) for converting the amplitude-modulated analog signal outputted from a photo-detector (503) into the digital signal, FFT(Fast Fourier Transform) converter (505) for performing FFT algorithm using a digital signal outputted from an analog/digital converter (504), and a power and optical frequency calculator (506) for calculating the magnitude ratio of the FFT signal. The sampling frequency and resolution for an analog/digital converter (504) in the present invention are 250 KHZ and 12 bits, respectively.

A star coupler (501) is connected to a fiber optic line, and extracts the portion of the WDM optical signal including the frequency-modulated component. Further, a demultiplexer (502) demultiplexs the WDM optical signal including the frequency-modulated component. The transmission characteristics (e.g., the loss) of an optical signal passing through demultiplexer (502) is variable according to an optical frequency of each channel.

The demultiplexer (502) may be comprised using an Arrayed Waveguide Grating or a Mach-Gender interferometer of which transmission characteristics is a transposition characteristics with respect to an optical frequency, and comprised of a band-pass filter as well as an optical coupler for transmission characteristics to have the transposition characteristics.

Further, the demultiplexer (502) may be comprised of an optical coupler as well as a solid Fabry-Perot etalon filter or a fiber optic Fabry-Perot etalon filter for transmission characteristics to have the transposition characteristics, and may be comprised of an optical circulator and a fiber optic grating filter for transmission characteristics to have transposition characteristics around operating frequency.

Further, the demultiplexer (502) may be comprised that the channel distance of a WMD optical signal is identical to that of an Arrayed Waveguide Grating, or multiple.

FIG. 6 is a diagram illustrating the transmission characteristics of an Arrayed Waveguide Grating with 200 GHZ channel distance and 30 dB crosstalk. Since the transmission characteristics of an arrayed waveguide grating is moving according to an optical frequency if temperature is changed, the temperature control using a thermoelectric cooler and a thermistor is performed in order to match the transposition point frequency of an arrayed waveguide grating with a standard frequency of a WDM optical signal. In other word, a WDM optical signal is operating around each transposition points of a arrayed waveguide grating. In FIG. 6, the number over transmission characteristics denotes the port number of an arrayed waveguide grating. f1-f7 means the modulating frequency of a modulated optical frequency component in each optical signal, and is low frequency such as several hundreds KHZ.

Accordingly, when an optical signal is operated at the transposition point of an arrayed waveguide grating, the magnitude of each optical signal outputted from adjacent two ports of an arrayed waveguide grating is same. If an optical frequency of an optical signal is changed, the magnitude of each optical signal outputted from adjacent two ports is changed in accordance with the transmission characteristics of an arrayed waveguide grating.

When an optical signal including frequency-modulated component is passed through a demultiplexer (502), a photo-detector (503) attached on each output port of a demultiplexer (502) outputs an amplitude-modulated electrical signal according to the difference of a transmission characteristics. An analog/digital converter (504) converts the amplitude-modulated analog signal outputted from a photo-detector (503) into the digital signal. A FFT converter (505) performs FFT algorithm using the converted digital signal, and outputs the magnitude and frequency of an amplitude-modulated signal. Finally, a power and optical frequency calculator (506) calculates the magnitude ratio of the FFT transformed signal, and outputs a power and optical frequency of a WDM optical signal using the above signal ratio.

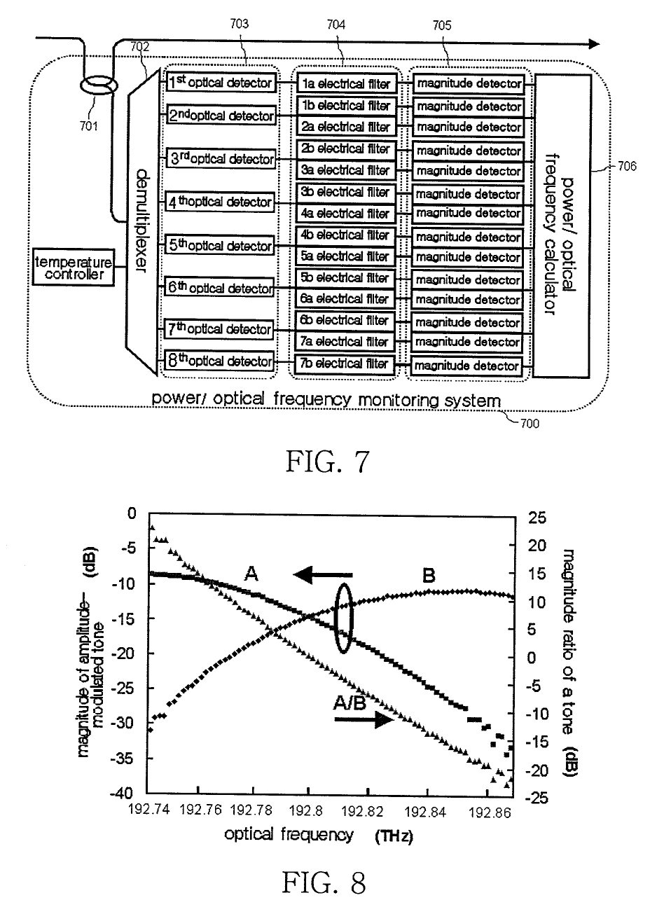

FIG. 7 is a configuration diagram depicting another embodiment of a monitoring device that observes an optical frequency using a demultiplexer in accordance with the present invention.

The monitoring system shown in FIG. 7 comprises a star coupler (701) for extracting the optical signal including the frequency-modulated component from a fiber optic line, a demultiplexer (702) for demultiplexing an optical signal inputting from a star coupler (701), a plurality of photo-detector (703) for measuring the magnitude of an optical signal outputted from a demultiplexer (702), a plurality of electrical filter (704) for extracting the signal of which frequency matches with each channel frequency, a magnitude detector (705) for measuring the magnitude of signal passed through a plurality of electrical filter, an optical frequency calculator (706) for calculating the power and optical frequency using the magnitude of the measured signal.

From now on, the operating principle of a monitoring system in FIG. 7 is discussed. The operating principle of a star coupler (701), a demultiplexer (702), and a plurality of photo-detector (703) are identical as the principle discussed in FIG. 5. A plurality of electrical filter (704) filtrate the output signal of a photo-detector (703).

A magnitude detector (705) measures the magnitude of signal passed through a plurality of electrical filter (704). An optical frequency calculator (706) estimates the power and optical frequency using the magnitude of the measured signal.

FIG. 8 is a diagram illustrating the magnitude and magnitude ratio of amplitude modulated tones according to the optical frequency, here, the amplitude-modulated tones are generated after the optical signal modulated by 14 KHZ (a fifth laser in FIG. 1) is passed the 1×8 Arrayed Waveguide Grating and photo-detector in the present invention.

An optical signal generally is operated at 192.8 THZ (f3 in FIG. 6). FIG. 8 illustrates the magnitude and magnitude ratio of the signals that are measured at a 3^{rd} port (A) and a 4^{th} port (B) of an arrayed waveguide grating while the frequency is changed from 192.74 THZ to 192.86 THZ. When the optical frequency is changed, the magnitude of an optical signal passed through an arrayed waveguide grating is changed in accordance with the transmission characteristics of an arrayed waveguide grating, and the magnitude of a amplitude-modulated signal is also changed according to the transmission characteristics (inclination (0.4 dB/GHZ)) with proportional to the magnitude of a frequency-modulated optical signal. Generally, since a WDM optical signal is operated at the transposition point of an arrayed guide grating, a photo-detector attached on each port of an arrayed guide grating detects two amplitude components having different frequencies.

For example, in FIG. 5, a 3^{rd} photo-detector attached on the 3^{rd} port of an arrayed waveguide grating detects frequencies (f1 and f3) of an amplitude-modulated signal, and a 4^{th} photo-detector attached on the 4^{th} port of an arrayed waveguide grating detects frequencies (f3 and f4) of an amplitude-modulated signal. Therefore, an optical frequency located at the transposition point of a 3^{rd} and 4^{th} port of an arrayed waveguide grating may be determined by comparing the frequency (f3) of a signal passed through the 3^{rd} port and the frequency (f3) of a signal passed through the 4^{th} port. Similarly, the magnitude of a modulated frequency (f2) is used for determining an optical frequency located at the transposition point of a 2^{nd} and 3^{rd} port, and the magnitude of a modulated frequency (f4) is used for determining an optical frequency located at the transposition point of a 4^{th} and 5^{th} port.

Accordingly, Even though two optical signals are inputted to each photo-detector, the modulated frequencies of a frequency-modulated component are not in accordance and are easy to identify so that the frequencies of each optical signal may be classified.

FIG. 8 shows the magnitude ratio of a amplitude-modulated signal and an optical frequency have a relationship such as one to one correspondence. Therefore, an optical frequency may be measured by using the magnitude ratio of a magnitude of a amplitude-modulated signal. Furthermore, since the difference of a magnitude of amplitude-modulated signals and an optical frequency also have a relationship such as one to one correspondence, an optical frequency may be measured by using this fact. Further, by utilizing the absolute magnitude of an amplitude-modulated signal that is measured at each port, the power of an optical signal can be monitored.

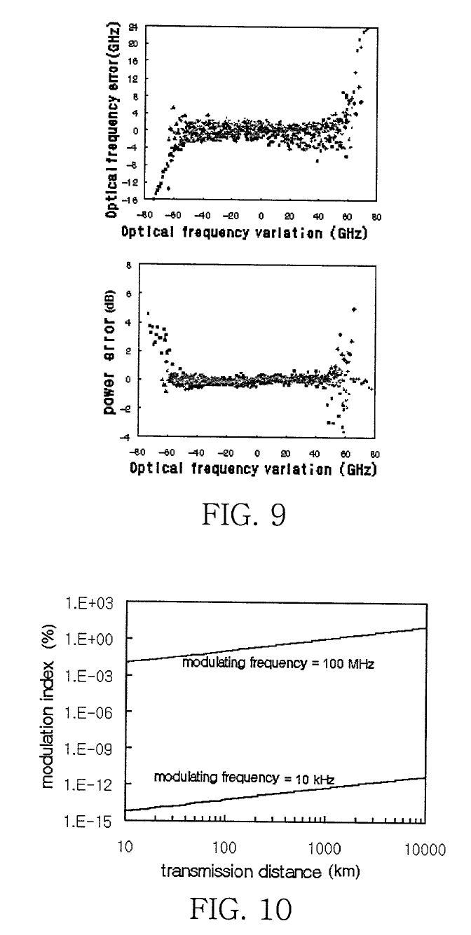

FIG. 9 is diagram showing experimental results measured before transmitting the WDM optical signals of seven channels through the single mode fiber optic, and illustrating the power error and optical frequency error between an optical signal measured by a power/optical frequency monitoring system and an optical signal measured by a commercial multi-wavelength measurement system.

It is known from FIG. 9 that an optical frequency can be monitored within ±4 GHZ measurement error bound, in the range of ±40 GHZ deviation from the standard frequency enacted by ITU (International Telecommunication Union). If an optical frequency is bigger than ±40 GHZ, the measurement error is increased. The reason of foregoing fact is based on followings: The bigger the frequency deviation from ITU standard frequency is, the smaller the magnitude of a amplitude-modulated signal becomes, and consequently the relative error is increased. Further, FIG. 9 shows that the measured power error is limited within ±1 dB, in the range of ±40 GHZ deviation from the standard frequency.

Since the monitoring system in accordance with the present invention utilizes the frequency modulation of a transmitter, the amplitude variation of a signal can occur due to the color dispersion of a fiber optic while the frequency-modulated optical signal passes through a fiber optic. Because the performance of a monitoring system is affected by an amplitude variation of an optical signal, this effect should be considered.

FIG. 10 is a diagram illustrating the ratio (modulation index) of the component modulated by color dispersion of fiber optic to the average power of an optical signal according to the length of a fiber optic. It is assumed that the frequency variation of a frequency-modulated optical signal is 1 GHZ, and the color dispersion value is 16 ps/km/nm. By real calculation, when the modulated frequency of a frequency-modulated component is low (e.g., 10 KHZ), the amplitude variation of a component is not appeared, but when the modulated frequency is high (e.g., more than 100 MHZ), the amplitude variation is very high. Therefore, the color dispersion of a fiber optic may be negligible because the modulated frequency ranges of 10 KHZ in the monitoring system.

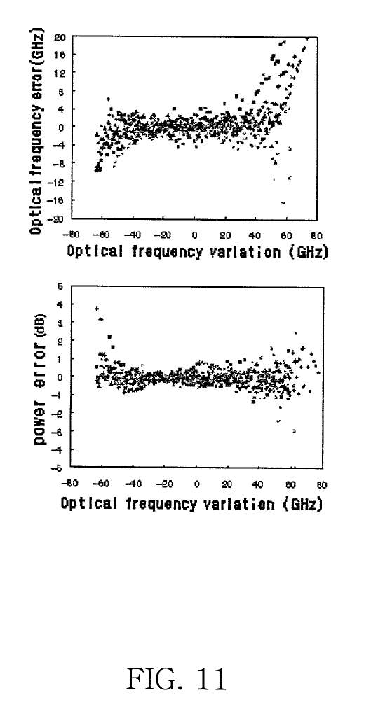

FIG. 11 is a exemplary diagram illustrating experimental results that is measured the power and optical frequency of a WDM optical signals of seven channels after transmitting the signal through a single mode fiber optic (640 km long) in accordance with the present invention.

The monitoring results of the power and optical frequency in FIG. 11 are not exceed ±1 dB and ±4 GHZ even though the signal is transmitted through a fiber optic 640 Km long, which shows the same monitoring result as before transmitting the signal.

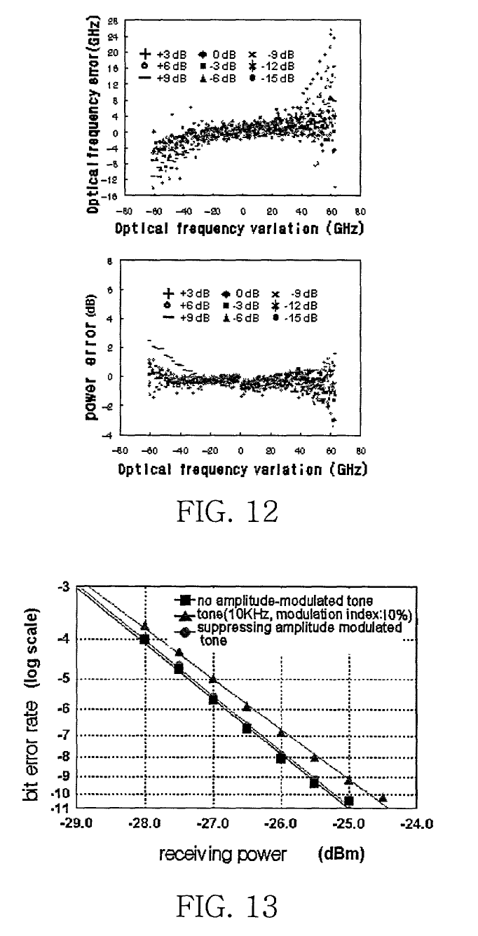

FIG. 12 is a diagram illustrating the error of the power and optical frequency of single channel while changing the power of WDM optical signals of seven channels after transmitting the signal through a single mode fiber optic (640 km long) in accordance with the present invention. The measurement errors are not altered even though the power is controlled from +6 dB to −12 dB.

FIG. 13 is a diagram illustrating the bit error rate of a data signal having 2.5 GB/s speed, with respect to the case of suppressing and case of non-suppressing the amplitude-modulated component, when the power and optical frequency of a WDM optical signal is monitored by a monitoring system in accordance with the present invention. It is known from FIG. 13 that the reception sensitivity by suppressing the amplitude variation is improved as much as about 0.5 dB in comparison with non-suppressing.

Since those having ordinary knowledge and skill in the art of the present invention will recognize additional modifications and applications within the scope thereof, the present invention is not limited to the embodiments and drawings described above.

What is claimed is:

1. A transmission system of an optical signal for monitoring the power and optical frequency of an optical signal, which utilized in an optical communication network using the wavelength division multiplexing method, comprising:
a laser for generating an optical signal; and
modulation means for modulating the frequency of an optical signal outputted from said laser.

2. A transmission system of an optical signal according to claim 1, wherein said modulation means further comprising:
a tone generator for modulating the frequency of an optical signal outputted from said laser by applying a tone signal to an optical signal outputted from said laser;
a phase controller for generating the sinusoidal current having the inverse phase with respect to said tone signal; and
a light modulator operated by the sinusoidal current of said phase controller for suppressing the amplitude variation of an optical signal due to said tone generator.

3. A transmission system of an optical signal according to claim 1, wherein said modulation means further comprising:
a RF signal generator; and
a phase modulator controlled by said RF signal generator for modulating the frequency of an optical signal outputted from said laser.

4. A transmission system of an optical signal according to claim 1, wherein said modulation means is characterized as the temperature control circuit which modulates the frequency of an optical signal outputted from said laser by controlling the temperature of said laser.

5. A monitoring system for monitoring a power and an optical frequency of a frequency-modulated optical signal, which is utilized in an optical communication network using the wavelength division multiplexing method, comprising:
a star coupler for extracting said frequency-modulated optical signal from a fiber optic line;
demultiplex means for demultiplexing an optical signal outputted from said star coupler;
photo-detection means for measuring the magnitude of an optical signal of which an amplitude is altered by said demultiplex means; and
extraction means for extracting a power and an optical frequency of an optical signal by using the magnitude of a signal of measured at said photo-detection means.

6. A monitoring system for monitoring a power and an optical frequency according to claim 5, wherein said demultiplex means is characterized as the demultiplexer using an arrayed waveguide grating, of which transmission characteristics is the transposition characteristics with respect to an optical frequency.

7. A monitoring system for monitoring a power and an optical frequency according to claim 5, wherein said demultiplex means is characterized as the demultiplexer using a Mach-Gender interferometer, of which transmission characteristics is the transposition characteristics with respect to an optical frequency.

8. A monitoring system for monitoring a power and an optical frequency according to claim 5, wherein said demultiplex means is characterized as the demultiplexer using band-pass filters and optical couplers, of which transmission characteristics is the transposition characteristics with respect to an optical frequency.

9. A monitoring system for monitoring a power and an optical frequency according to claim 5, wherein said demultiplex means is characterized as the demultiplexer using an optical coupler and a solid Fabry-Perot etalon filter, of which transmission characteristics is the transposition characteristics with respect to an optical frequency.

10. A monitoring system for monitoring a power and an optical frequency according to claim 5, wherein said demultiplex means is characterized as the demultiplexer using an optical coupler and a fiber optic grating filter, of which transmission characteristics is the transposition characteristics with respect to an optical frequency.

11. A monitoring system for monitoring a power and an optical frequency according to claim 5, wherein said demultiplex means is characterized as the demultiplexer of which transmission characteristics is the transposition characteristics with respect to an optical frequency, at the frequency range operated the WDM optical signal.

12. A monitoring system for monitoring a power and an optical frequency according to claim 5, wherein said demultiplex means is characterized as the channel distance of a WMD optical signal is identical to that of an arrayed waveguide grating, or multiple.

13. A monitoring system for monitoring a power and an optical frequency according to claim 5, wherein said extraction means further comprising:
analog/digital conversion means for converting the analog signal outputted from said photo-detector into the digital signal;
FFT (Fast Fourier Transform) conversion means for performing FFT algorithm using a digital signal outputted from said analog/digital conversion means, and for extracting the magnitude of the frequency-modulated signal; and
a calculator for calculating the magnitude ratio of an amplitude-modulated signal outputted from said FFT conversion means to extract a power and an optical frequency of a signal.

14. A monitoring system for monitoring a power and an optical frequency according to claim 5, wherein said extraction means further comprising:
an electrical filter for filtering the signal outputted from said photo-detection means, and for extracting the signal of which frequency matches with a specific frequency,
a magnitude detector for measuring the magnitude of signal outputted from said electrical filter,
a calculator for calculating a power and an optical frequency using the magnitude of a signal measured at said magnitude detector.

15. A monitoring system for monitoring a power and an optical frequency according to claim 13, wherein said calculator extracts a power and an optical frequency of a signal using the magnitude and magnitude ratio of an amplitude-modulated signal.

16. A monitoring system for monitoring a power and an optical frequency according to claim 14, wherein said calculator extracts a power and an optical frequency of a signal using the magnitude and magnitude ratio of an amplitude-modulated signal.

17. A monitoring system for monitoring a power and an optical frequency according to claim 13, wherein said calculator extracts a power and an optical frequency of a signal using the magnitude and magnitude error of an amplitude-modulated signal.

18. A monitoring system for monitoring a power and an optical frequency according to claim 14, wherein said calculator extracts a power and an optical frequency of a signal using the magnitude and magnitude error of an amplitude-modulated signal.
